(19) United States
(12) Patent Application Publication
(10) Pub. No.: US 2007/0283553 A1
(43) Pub. Date: Dec. 13, 2007

(54) METHOD OF PROVIDING A FLANGED CONNECTION

(76) Inventor: MATHEW DAVIS, Barnstable (GB)

Correspondence Address: JOHN MOLNAR JR., PARKER-HANNIFIN CORPORATION, 6035 PARKLAND BOULEVARD, CLEVELAND, OH, 44124-4141, US

(21) Appl. No.: 11/832,164

(22) Filed: Aug. 1, 2007

Related U.S. Application Data
(63) Continuation of application No. PCT/GB06/00310, filed on Jan. 27, 2006.

(30) Foreign Application Priority Data
Feb. 2, 2005 (GB) 0502164.7

(51) Int. Cl. B23P 11/00

(52) U.S. Cl. 29/525.01

(57) ABSTRACT

A method of providing a flanged component and a flanged component constructed by such method. The method includes providing a shaft, providing a flange with an aperture, passing the aperture of the flange over the shaft and securing the flange to the shaft. The flange may be provided at one end portion of the shaft and a connector may be provided at the other end portion of the shaft to connect the flanged component to another component. The connector may be, for example, an integral flange, a further flange with an aperture or a threaded end portion of the shaft.

### CROSS REFERENCE TO RELATED APPLICATIONS

This application is continuation of co-pending International Application No. PCT/GB06/000310 filed Jan. 27, 2006, which application designated the United States, and which application claims priority to Great Britain Patent Application No. 0502164.7, filed Feb. 2, 2005, the disclosure of each of which applications is incorporated herein by reference.

### BACKGROUND OF THE INVENTION

The present invention relates to the provision of a flanged component. The flanged component may have a flange, as shown at 1 and 2, provided on each axial side of an undercut, 3, to provide a twin flanged component as shown in the cross sectional view of FIG. 1.

The flanges and undercut generally, but not exclusively, have a circular cross-section. At least one of the flanges is provided with holes therethrough as shown by the broken lines such as referenced at 4 in FIG. 1. The holes are generally provided around the circular periphery of the flange for bolts to be passed therethrough to connect the flanges to other components. The bolts will generally be secured with nuts. The undercut is required to provide access to allow the nuts and bolts to be fitted.

The twin flanged component shown in FIG. 1 is currently manufactured from a single piece of material, preferably by forging to enable the grain flow of the material used to follow the shape of the component and provide the inherent strength the component requires in use. The component can be formed by either closed die forging with a relatively small amount of subsequent machining required to achieve the final shape of the component or by open die forging with a relatively large amount of subsequent machining required to achieve the final shape of the component. FIG. 2 shows an example of a twin flanged component with an outline on the left hand side showing the shape, as at 5, that is typically achieved as a result of closed die forging and an outline on the right hand side showing the shape, as at 6, that is typically achieved as a result of open die forging. As can be seen, only a relatively small amount of machining will be required for the component manufactured by closed die forging in order to achieve the final shape of the component. However, in order to be able to provide a range of different sizes of flange, as will be required by a range of users, a different tooling set has to be provided for each size. This considerably increases costs, for both acquisition and maintenance of the plurality of tooling sets required. A component manufactured by open die forging can be machined to produce a flange of a number of different seizes. However, machining to produce the undercut requires machining across the grain of the component which produces a point of weakness which is liable to fail during use. Furthermore, attempts to forge newer materials can prove troublesome. For example attempts to forge Inconel 625 with large shape changes such as the undercut 3 shown in FIG. 1 have shown that it is susceptible to cracking.

### BRIEF SUMMARY OF THE INVENTION

According to a first aspect to the present invention, there is provided a method of providing a flanged component, the method comprising
providing a shaft;
providing a flange with an aperture;
passing the aperture of the flange over the shaft and
securing the flange to the shaft.

Such a flanged component overcomes or alleviates the problems discussed above, such as the weakness at the undercut of machined open die forged components, the expensive tooling required to be able to provide varieties of sizes of closed die forged components and the possible problems associated with forging materials such as Inconel 625 and others.

In the present invention, each of the shaft and the flange may be manufactured individually, preferably by the less expensive open die forging to reduce costs as they each have final shapes which are close to those produced by open die forging such that only minimal machining is required.

Flanges may be any shape and orientation.

The components can also be formed in such a way as to create an adaptor flange.

The shaft may have an integral flange such that the attaching of the flange with a central aperture produces a twin or two-flanged component. Even if the flanges are different sizes, a final component may still be termed a twin or two flanged component.

A flange of any one of a variety of sizes may be secured to the shaft providing considerable flexibility.

According to a second aspect of the present invention there is provided a flanged component constructed by the method of the first aspect of the present invention.

### BRIEF DESCRIPTION OF THE DRAWINGS

An example of the present invention will now be described by reference to the accompanying drawings, in which:

FIG. 1 shows a cross-sectional view of a twin flanged component in accordance with the prior art;

FIG. 2 shows an example of a twin flanged component with an outline on the left hand side indicating the shape that is typically achieved as a result of closed die forging and an outline on the right hand side indicating the shape that is typically achieved as a result of open die forging;

FIG. 3 shows a cross-sectional view of a shaft with an integral flange to be used in a first example of the present invention;

FIG. 4 shows the shaft of FIG. 3 with a flange with an aperture fitted over the shaft;

FIG. 5 shows the shaft of FIG. 4 with a pair of split rings attached thereto;

FIG. 6 shows the component of the first example complete with the flange with an aperture secured to the shaft;

FIG. 7 shows a perspective view of the complete component of the first example;

FIG. 8 shows a schematic cross-section through a shaft used in a second example of the present invention;

FIG. 9 shows the shaft of FIG. 8 with flanges fitted thereto;

FIG. 10 shows a schematic cross-section through a shaft used in a third example of the present invention; and

FIG. 11 shows the shaft of FIG. 10 with a flange attached thereto.

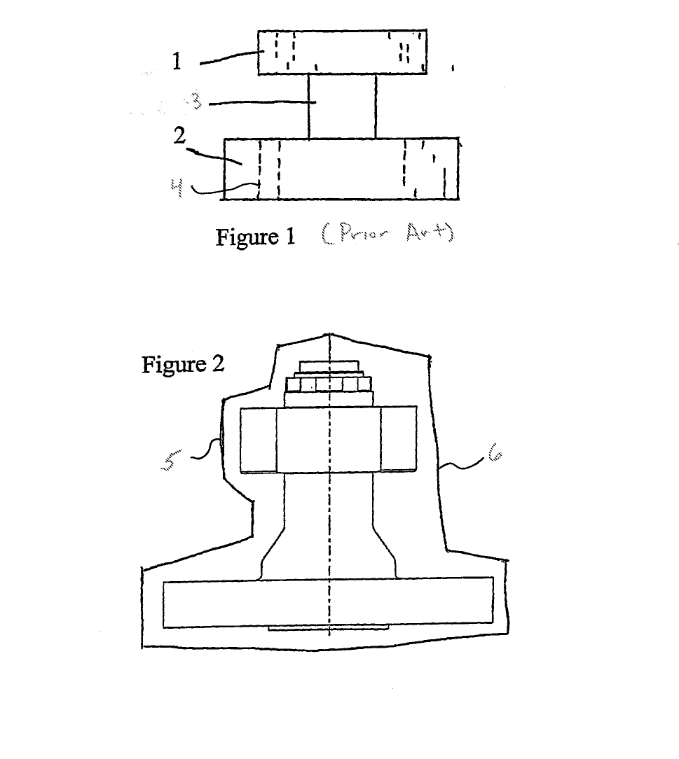

### DETAILED DESCRIPTION OF THE INVENTION

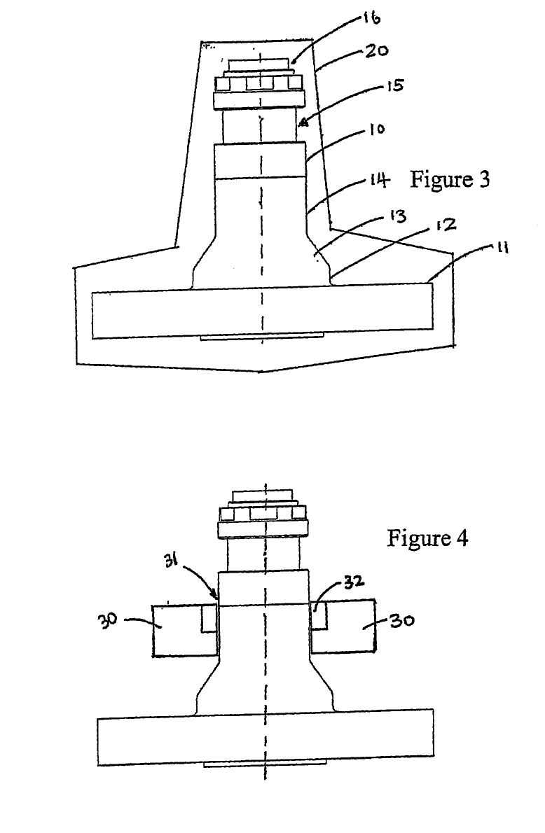

FIG. 3 is a cross-sectional view of a shaft 10 with an integral flange 11. The line 20 shown around the shaft 10 and integral flange 11 shows the shape that is typically achieved by lower cost open die forging of this component. As can be seen, only minimal machining is required to achieve the final shape. The shaft 10 of this example is connected to integral flange 11 by a base portion 12. A frusto-conical portion 13 interconnects the base portion 12 to a main portion 14 of the shaft. The main portion 14 of this example has an annular groove 15 to accommodate split rings for securing a flange with an aperture (to be described later). It should be noted that the groove and/or split ring do not have to have a square/rectangular section nor does it need to be a pair of split rings or even necessarily a complete ring, it could be just half a ring for example. Above the main portion 14 is an optional arrangement 16 to mate with another component to be joined to the complete double flange and shaft component. The details of the shaft 10 described in this example are optional and any suitable shaft 10 profile will be suitable provided it can be joined to a flange with an aperture.

FIG. 4 shows the shaft 10 of FIG. 3 with a flange 30 having a central aperture 31 fitted over the shaft 10. This flange 30 has a recess 32 on the inside surface of the central aperture 31 to engage with split rings to be described later.

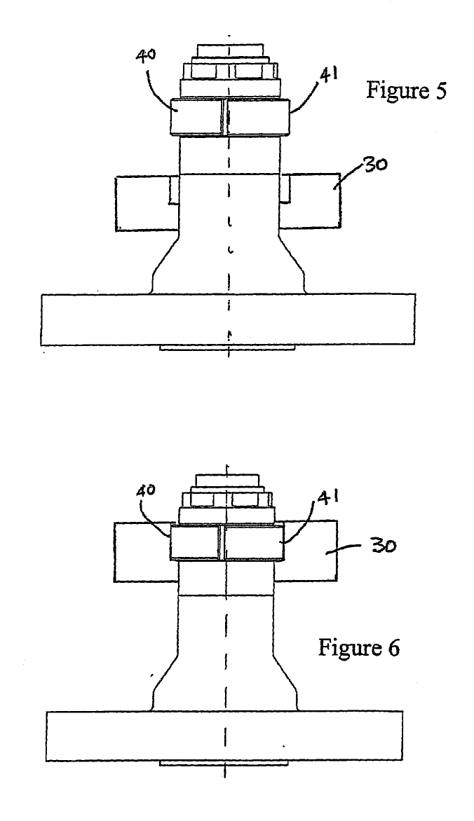

FIG. 5 shows the shaft 10 with a pair of split rings 40, 41 inserted into the annular groove 15. Instead of the pair of split rings 40, 41, a single or three or more split rings could be provided in the groove 15. Furthermore it or they do not need to be a complete ring.

FIG. 6 shows the component complete with the flange 30 slid up the shaft 10 into engagement with and restrained by the split rings 40, 41 as is well known by those skilled in the art.

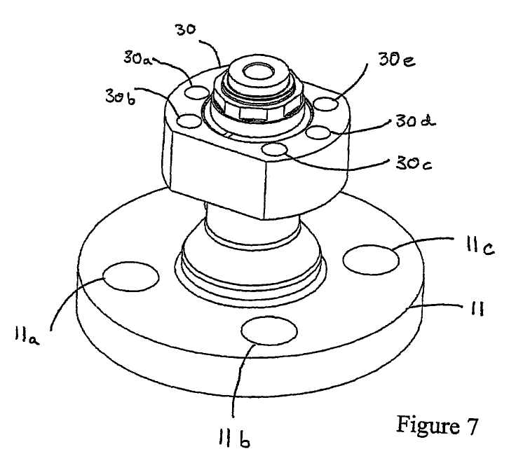

FIG. 7 shows a perspective view of the complete component. As can be seen, integral flange 11 and flange 30 are each provided with holes 11a, 11b, 11c and 30a, 30b, 30c, 30d, 30e respectively for connecting means such as bolts to be passed through (not shown) to secure the flanges 11, 30 to adjacent components (not shown).

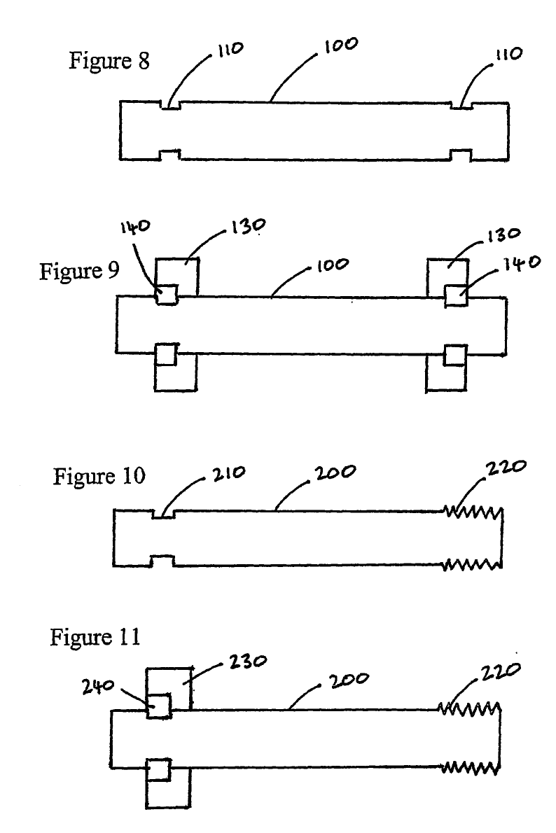

FIG. 8 shows a schematic cross-section through a shaft 100 to be used in a second example of the present invention. In this example the shaft 100 is provided with two axially spaced annular grooves 110 to accommodate split rings for securing flanges with apertures. The annular grooves 110 and split rings do not need to have a square or rectangular cross-section as shown, but could have any suitable cross-section. Nor do the split rings need to comprise a pair of split rings, but could be any suitable number. The split ring or rings do not even need to be a complete ring.

Flanges 130 are slid over the end portion(s) of the shaft 100 and temporarily rest on the shaft 100 between annular grooves 110 whilst split rings 140 are fitted into the annular grooves 110 and the flanges 130 are then slid into engagement with the split rings 140 held in annular grooves 110 as shown in FIG. 9.

One or both flanges 130 may be provided with holes (not shown) for connecting means such as bolts to be passed through to secure the flanges 130 to adjacent components (not shown).

It is often necessary to align the holes of each flange 11, 30; 130 relative to each other for appropriate relative orientation of the components to which the flanges 11, 30; 130 are to be attached. This may be achieved by providing corresponding interlocking profiles on the outside surface of the shaft 10; 110 and the inside surface of the aperture 31 of the flange 30; 130 or the inside surface of the mating components (not shown). For example, a portion of the outside surface of the shaft 10; 110 to which the flange 30; 130 is secured may be provided with a suitable profile, such as hexagonal, circular with a flat, square or triangular to engage a corresponding profile on the inside surface of the aperture 31 of the flange 30; 130.

FIG. 10 shows a schematic cross-section through a shaft 200 to be used in a third example of the present invention. In this example the shaft 200 is provided with an annular groove 210 to accommodate one or more split rings for securing a flange with an aperture. The annular groove 210 and one or more split rings do not need to have a square or rectangular cross-section as shown, but could have any suitable cross-section. Nor do the split rings need to comprise a pair of split rings, but could be any suitable number. The split ring or rings do not even need to be a complete ring. One end portion of the shaft 200 is threaded 220 to enable it to be joined via the threads to another component (not shown).

A flange 230 is slid over an end portion of the shaft 200 and temporarily rests on the shaft 200 whilst one or more split rings 240 are fitted into the annular groove 210 and the flange 230 is then slid into engagement with the split ring 240 held in annular groove 210 as shown in FIG. 11.

The flange 230 may be provided with holes (not shown) for connecting means such as bolts to be passed through to secure the flange 230 to an adjacent component (not shown).

The flange 30; 130; 230 may be held in place on the shaft 10; 100; 200 by any suitable means such as the split rings 40, 41; 140; 240 described above or, for example by engagement with the shaft 10; 100; 200 in some other suitable manner such as by the provision of one or more restraining means such as bolts to be passed through the flange 30; 130; 230 and into engagement with the shaft 10; 100; 200.

Many variations may be made to the examples described above without departing from the scope of the invention. For example, the shaft 10; 100; 200, integral flange 11 and flange 30; 130; 230 could be made from any suitable material. The profile of the shaft 10; 100; 200 could be a cylinder or any suitable elongate shape.

As it is anticipated that certain changes may be made in the present invention without departing from the precepts herein involved, it is intended that all matter contained in the foregoing description shall be interpreted as illustrative and not in a limiting sense. All references including any priority documents cited herein are expressly incorporated by reference.

What is claimed is:

1. A method of making a flanged component comprising the steps of:
(a providing a shaft;
(b providing a first flange having an aperture therethrough;
(c receiving the shaft through the aperture of the first flange; and
(d securing the first flange to the shaft.

2. The method of claim 1 wherein:
the shaft is provided in step (a) as having a first end portion and a second end portion; and
the first flange is secured in step (d) to one of the first or the second end portion of the shaft.

3. The method of claim 2 further comprising the additional step of:
providing a connector at the other one of the first or the second end portion of the shaft.

4. The method of claim 3 wherein the connector is a second flange formed integral with the shaft.

5. The method of claim 2 further comprising the additional steps of:
providing a second flange having an aperture therethrough;
receiving the shaft through the aperture of the second flange; and
securing the second flange to the shaft at the other one of the first or second end portion of the shaft.

6. The method of claim 5 wherein the shaft is provided in step (a) as having a first and a second annular groove each formed circumferentially therein at a corresponding end portion of the shaft, the aperture of the first flange provided in step (b) has an inner surface with a first annular recess formed circumferentially therein, the method further comprising the additional step prior to step (d), and the aperture of the second flange provided as having an inner surface with a second annular recess formed circumferentially therein, the method further comprising the additional step of:
inserting one or more retaining rings into each of the first and the second groove,
wherein the first shaft is received through the aperture of the first flange in step (c) with the recess of the aperture thereof facing the first groove of the shaft,
wherein the second shaft is received through the aperture of the second flange with the recess of the aperture thereof facing the second groove of the shaft,
wherein the first flange is secured to the shaft in step (b) by sliding the first flange towards the first groove of the shaft such that the one or more retaining rings received in the first groove of the shaft are received in the first recess of the first flange, and
wherein the second flange is secured to the shaft in step (b) by sliding the second flange towards the second groove of the shaft such that the one or more retaining rings received in the second groove of the shaft are received in the second recess of the second flange.

7. The method of claim 5 wherein:
the shaft is provided in step (a) as having an outer surface with a first profile portion formed therein;
the apertures of the first and the second flanges are provided as each having an inner surface with a second profile portion formed therein, the first and the second profile being configured to be interlocking when the second profile is received over the first profile; and
the first and the second flange is secured to the shaft with the second profile thereof being received over the first profile such that the first flange and the second flange each is aligned on the shaft in a predetermined orientation relative to the other flange.

8. The method of claim 1 wherein the shaft is provided in step (a) as having an annular groove formed circumferentially therein, and the aperture of the first flange provided in step (b) has an inner surface with an annular recess formed circumferentially therein, the method further comprising the additional step prior to step (d) of:
inserting one or more retaining rings into the groove,
wherein the shaft is received through the aperture of the first flange in step (c) with the recess of the aperture facing the groove of the shaft, and
wherein the first flange is secured to the shaft in step (b) by sliding the first flange towards the groove of the shaft such that the one or more retaining rings are received in the recess of the first flange.

9. The method of claim 1 wherein:
the shaft is provided in step (a) as having an outer surface with a first profile portion formed therein;
the aperture of the first flange provided in step (b) has an inner surface with a second profile portion formed therein, the first and the second profile being configured to be interlocking when the second profile is received over the first profile; and
the first flange is secured to the shaft in step (d) with the second profile being received over the first profile.

10. The flanged component made by the method of claim 1, 5, 6, 7, 8, or 9.
